(19) United States
(12) Patent Application Publication
(10) Pub. No.: US 2008/0019750 A1
(43) Pub. Date: Jan. 24, 2008

(54) Fixing device and temperature control method

(75) Inventor: Hirotaka Matsumoto, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/491,672

(22) Filed: Jul. 24, 2006

(51) Int. Cl. G03G 15/00

(52) U.S. Cl. 399/400

(57) ABSTRACT

To provide a fixing technique that can control occurrence of fixing failure in image formation processing immediately after warm-up from a state in which a heating roller is cold.

A fixing device includes: at least one first heating unit that heats portions near ends in a rotation axis direction of the heating roller; a second heating unit that heats the center in the rotation axis direction of the heating roller; a temperature difference judging unit that judges whether a temperature difference between the heating roller and the pressure roller is equal to or larger than a predetermined value; and a heating control unit that controls, in the case in which the temperature difference judging unit judges that a temperature difference is equal to or larger than the predetermined value when predetermined heat processing for making it possible to perform fixing processing in the fixing device is started by the first heating unit, a supplied heat quantity per a unit time by the first heating unit in a period from a start time of the predetermined heat processing by the first heating unit until a start time of the fixing processing to be larger than a supplied heat quantity per a unit time by the first heating unit at the time of fixing processing.

### BACKGROUND OF THE INVENTION

1. Field of the Invention

The present invention relates to a fixing technique for heat-fixing a toner image on a sheet, and, more particularly to a heating control technique for a heating roller.

2. Description of the Related Art

In recent years, among fixing devices adopting a roller fixing system, there is a fixing device that adopts a thin heating roller in order to reduce warm-up time taking the environment into account.

However, in the fixing device that uses the thin heating roller, since a temperature change of the heating roller is large, temperature unevenness of the heating roller tends to increase. In an image forming apparatus including such a fixing device that uses the thin heating roller, when a print operation is performed immediately after warm-up from a state in which the heating roller is cold, there is a problem in that a fixing failure image due to temperature fall (an undershoot phenomenon) caused by deprivation of heat by a pressure roller or a transfer sheet, which is in contact with the heating roller, occurs. Such a fixing failure image occurs, in particular, near ends of the heating roller where heat radiation is large.

When a control temperature is set taking into account a fixing failure image due to temperature fall at the ends of the heating roller immediately after warm-up, there is a problem in that longer time is required for the warm-up.

### SUMMARY OF THE INVENTION

The invention has been devised in order to solve the problems described above and it is an object of the invention to provide a fixing technique that can control occurrence of a fixing failure in image formation processing immediately after warm-up from a state in which a heating roller is cold.

In order to solve the problems, a fixing device according to an aspect of the invention is a fixing device that brings a sheet having a toner image transferred thereon into press-contact with a heating roller using a pressure roller to heat-fix the toner image on the sheet and causes the sheet to pass in a center position in a rotation axis direction of the heating roller, characterized by including: at least one first heating unit that heats portions near ends in a rotation axis direction of the heating roller; a second heating unit that heats the center in the rotation axis direction of the heating roller; a temperature difference judging unit that judges whether a temperature difference between the heating roller and the pressure roller is equal to or larger than a predetermined value; and a heating control unit that controls, in the case in which the temperature difference judging unit judges that a temperature difference is equal to or larger than the predetermined value when predetermined heat processing for making it possible to perform fixing processing in the fixing device is started by the first heating unit, a supplied heat quantity per a unit time by the first heating unit in a period from a start time of the predetermined heat processing by the first heating unit until a start time of the fixing processing to be larger than a supplied heat quantity per a unit time by the first heating unit at the time of fixing processing.

A fixing device according to another aspect of the invention is a fixing device that brings a sheet having a toner image transferred thereon into press-contact with a heating roller using a pressure roller to heat-fix the toner image on the sheet and causes the sheet to pass in a center position in a rotation axis direction of the heating roller, characterized by including: at least one first heating means for heating portions near ends in a rotation axis direction of the heating roller; second heating means for heating the center in the rotation axis direction of the heating roller; temperature difference judging means for judging whether a temperature difference between the heating roller and the pressure roller is equal to or larger than a predetermined value; and heating control means for controlling, in the case in which the temperature difference judging means judges that a temperature difference is equal to or larger than the predetermined value when predetermined heat processing for making it possible to perform fixing processing in the fixing device is started by the first heating means, a supplied heat quantity per a unit time by the first heating means in a period from a start time of the predetermined heat processing by the first heating means until a start time of the fixing processing to be larger than a supplied heat quantity per a unit time by the first heating means at the time of fixing processing.

A temperature control method according to still another aspect of the invention is a temperature control method in a fixing device that brings a sheet having a toner image transferred thereon into press-contact with a heating roller using a pressure roller to heat-fix the toner image on the sheet and causes the sheet to pass in a center position in a rotation axis direction of the heating roller, the fixing device including at least one first heating unit that heats portions near ends in a rotation axis direction of the heating roller and a second heating unit that heats the center in the rotation axis direction of the heating roller, the temperature control method including: judging whether a temperature difference between the heating roller and the pressure roller is equal to or larger than a predetermined value; and controlling, in the case in which it is judged that a temperature difference is equal to or larger than the predetermined value when predetermined heat processing for making it possible to perform fixing processing in the fixing device is started by the first heating unit, a supplied heat quantity per a unit time by the first heating unit in a period from a start time of the predetermined heat processing by the first heating unit until a start time of the fixing processing to be larger than a supplied heat quantity per a unit time by the first heating unit at the time of fixing processing.

### DESCRIPTION OF THE DRAWINGS

FIG. 1 is an overall diagram for schematically explaining an apparatus structure of an image forming apparatus M including a fixing device 1 according to an embodiment of the invention;

FIG. 2 is a schematic sectional view for explaining a structure of the fixing device 1 according to the embodiment;

FIG. 3 is a diagram showing a luminous intensity distribution of heater lamps in a heating roller 102;

FIG. 4 is a diagram showing a relation between a passing position of a sheet with respect to the heating roller 102 and the luminous intensity distribution of the heater lamps;

FIG. 5 is a diagram for explaining lighting control for a heater lamp 109A and a heater lamp 109B;

FIG. 6 is a functional block diagram for explaining the fixing device 1 and the image forming apparatus M including the same according to the embodiment;

FIG. 7 is a graph showing a temperature change in a heating roller at the time when a copy operation is performed immediately after warm-up from a state in which the heating roller and a pressure roller are cold in control for alternately lighting two heater lamps in a conventional fixing device;

FIG. 8 is a graph showing a temperature change in the heating roller at the time when a copy operation is performed immediately after warm-up from a state in which the heating roller and the pressure roller are cold in the control for alternately lighting the two heater lamps in the conventional fixing device;

FIG. 9 is a graph showing a relation between the temperature of the heating roller 102 and an area of occurrence of image stain (surface stain);

FIG. 10 is a graph showing a relation between an unattended time of the image forming apparatus M in a standby state and a temperature change amount of the heating roller 102 at a start time of copy;

FIG. 11 is a flowchart for explaining a flow of processing in the fixing device according to the embodiment;

FIG. 12 is a table showing control conditions in heating control by the heating roller 102;

FIG. 13 is a flowchart for explaining a schematic flow of processing (a temperature control method) in the fixing device according to the embodiment; and

FIG. 14 is a graph showing a temperature change in the heating roller at the time when a copy operation is performed immediately after warm-up from a state in which the fixing device is cold in the case in which two heater lamps are alternately lighted in the fixing device according to the embodiment.

### DETAILED DESCRIPTION OF THE EMBODIMENTS

An embodiment of the invention will be hereinafter explained with reference to the drawings.

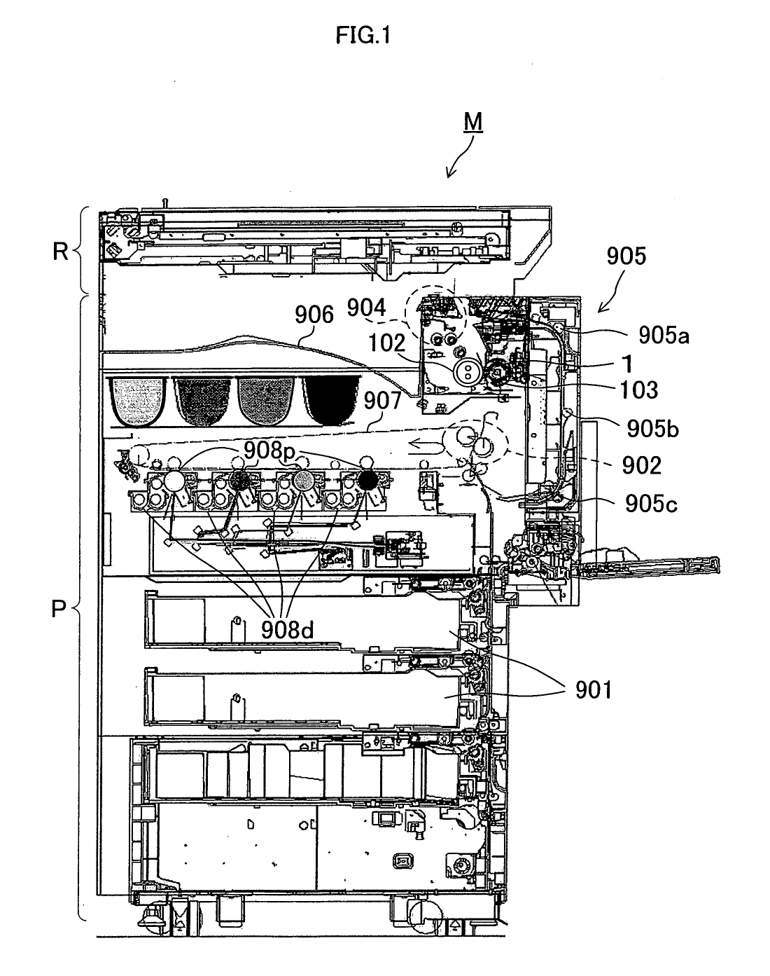

FIG. 1 is an overall diagram for schematically explaining an apparatus structure of an image forming apparatus M including a fixing device 1 according to an embodiment of the invention. As shown in the figure, the image forming apparatus M according to this embodiment includes an image reading unit R that reads an image of an original and an image forming unit P that forms an image on a sheet.

The image forming unit P includes a sheet feeding cassette 901, a transfer unit 902, a fixing device 1, a switchback conveying unit 904, an ADU (Automatic Duplex Unit) 905, a discharge tray 906, and an intermediate transfer belt 907. A flow of duplex printing on a sheet in the image forming apparatus M according to this embodiment will be hereinafter schematically explained.

A sheet supplied (fed) to a sheet conveying path by the sheet feeding cassette 901 is conveyed through the sheet conveying path to move to the transfer unit 902. During the conveyance, an electrostatic latent image formed on a photosensitive drum (an image bearing member) 908p is visualized as a toner image by a developing unit 908d and transferred onto the intermediate transfer belt 907 (so-called primary transfer).

The toner image transferred onto a belt surface of the intermediate transfer belt 907 is transferred onto a first surface of the sheet by the belt surface and the transfer unit 902 including a transfer roller (a transfer member) (so-called secondary transfer).

Subsequently, the sheet having the toner image transferred thereon is conveyed to the fixing device 1. The toner image is heat-fixed on the first surface. The fixing device 1 includes a heating roller 102 heated by a heater and a pressure roller 103. The fixing device 1 brings the sheet having the toner image secondarily transferred thereon into press-contact with the heating roller 102 using the pressure roller 103 to heat-fix the toner image on the sheet.

The sheet having the toner image heat-fixed thereon is conveyed to the switchback conveying unit 904 and switchback-conveyed by the switchback conveying unit 904 to be brought into the ADU 905. The switchback conveying unit 904 and the ADU 905 perform reversal of the sheet at the time of duplex printing of the sheet in cooperation with each other.

The sheet brought into the ADU 905 is conveyed through the ADU to move to the transfer unit 902 again. The toner image is formed on a second surface of the sheet. The sheet is conveyed to the fixing device 1.

The sheet having the toner images formed on both sides thereof is discharged onto the discharge tray 906. In an example described in this embodiment, a usual copy sheet is used as the sheet. However, the sheet is not limited to this. It is also possible to use cardboard, an OHP sheet, and the like.

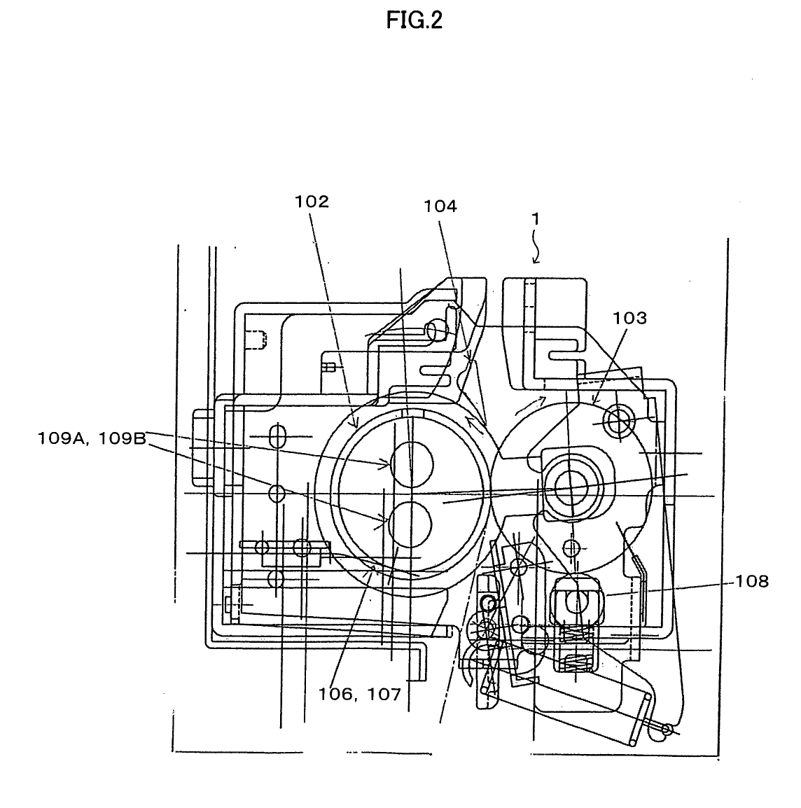

FIG. 2 is a schematic sectional view for explaining a structure of the fixing device 1 according to this embodiment.

The fixing device 1 includes a heating (fixing) roller 102 (φ30 mm) that heats a sheet having a toner image transferred thereon and a pressure (press) roller 103 (φ30) that brings the sheet having the toner image thereon into press-contact with the heating roller 102. The pressure roller 103 is in press-contact with the heating roller 102 by a pressing mechanism (not shown) and maintained to have a fixed nip width. The heating roller 102 is driven in an arrow direction by a drive motor (not shown). The pressure roller 103 rotates in an arrow direction following the heating roller 102. The fixing device 1 according to this embodiment causes the sheet to pass in a center position in a rotation axis direction of the heating roller 102.

For example, aluminum is used as a material of the heating roller 102. The heating roller 102 is formed in a cylindrical shape with thickness of 0.8 mm. A roller surface of the heating roller 102 in this embodiment is coated with a release layer of, for example, Teflon.

The pressure roller 103 is constituted by coating silicon rubber, fluorine rubber, or the like around a core metal. When a sheet passes a fixing point, which is a press-contact section (a nip section) of the heating roller 102 and the pressure roller 103, a toner image formed on this sheet is fuse-bonded and compression-bonded to be fixed.

On the outer periphery of the heating roller 102, a peeling pawl 104 that peels a sheet from the heating roller 102 and thermistors 106 and 107 (a relation with a heating position is describe later) that detect the temperature of the heating roller 102 are provided further on a downstream side in the rotation direction than a contact position (the nip section) of the heating roller 102 and the pressure roller 103. On the outer periphery of the pressure roller 103, a cleaning roller 108 is provided further on an upstream side in the rotation direction than the nip section.

As a heating system for the heating roller 102 in this embodiment, a system for using a halogen lamp (in an example, 564 W/one lamp) according to a heater lamp system is adopted.

When continuous copy is performed in an image forming apparatus, a temperature distribution in a rotation axis direction of a heating roller is substantially different depending on a size in a direction perpendicular to a conveying direction of a sheet that is caused to pass a fixing device. In particular, as in the case of a sheet with a small width size such as an A4-R sheet, when the heating roller has a portion where the sheet does not pass in the rotation axis direction of the heating roller, the temperature of the portion where the sheet does not pass (in the case of center sheet passing, corresponding to a heating roller end) may reach an abnormal temperature to cause breakage of components or an image failure such as a high-temperature offset image at the time of the next copy. Thus, in this embodiment, in view of such problems, a heating area in the rotation axis direction of the heating roller is divided and plural heater lamps with different luminous intensity distribution characteristics are used to make it possible to heat the respective heating areas individually.

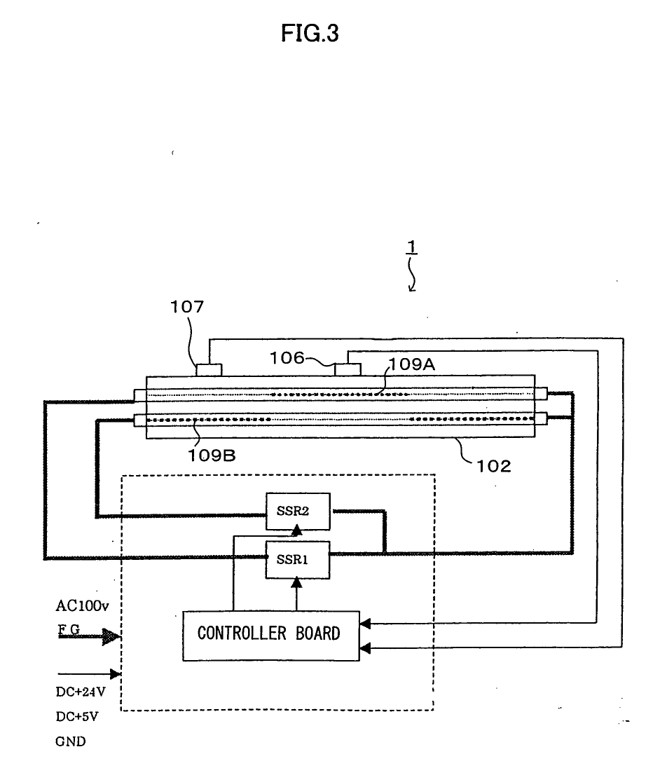

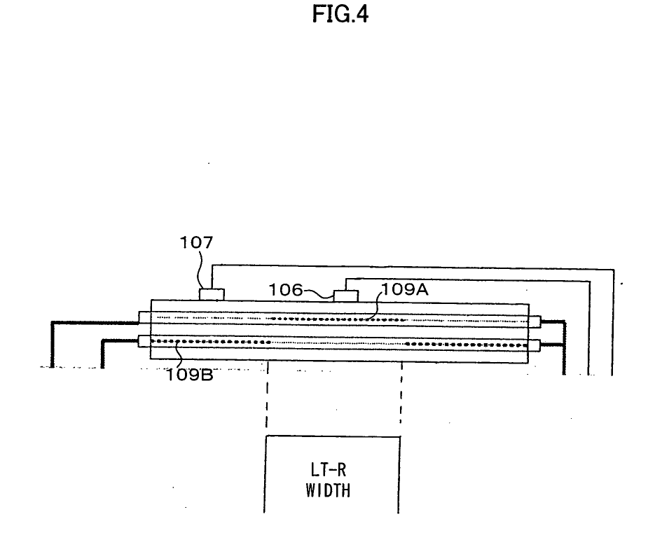

Specifically, the heater lamps are constituted by two heater lamps, namely, a heater lamp 109A and a heater lamp 109B. These heater lamps are arranged on the inner side of the heating roller 102. These heater lamps have different luminous intensity distributions depending on a heating position of the heating roller 102. FIG. 3 is a diagram showing a luminous intensity distribution of the heater lamps in the heating roller 102. FIG. 4 is a diagram showing a relation between a passing position of a sheet with respect to the heating roller 102 and the luminous intensity distribution of the heater lamps. In FIGS. 3 and 4, thick dotted line portions in the respective heater lamps indicate main heating areas.

As shown in FIGS. 3 and 4, the heater lamp 109A (a second heating unit) that heats the center in the rotation axis direction of the heating roller 102 mainly heats a range in which a small-sized sheet is caused to pass (equal to or smaller than an LT-R width). The heater lamp 109B (a first heating unit) that heats portions near ends in the rotation axis direction of the heating roller 102 mainly heats a range in which a large-sized sheet is caused to pass (a range in which the small-sized sheet does not pass).

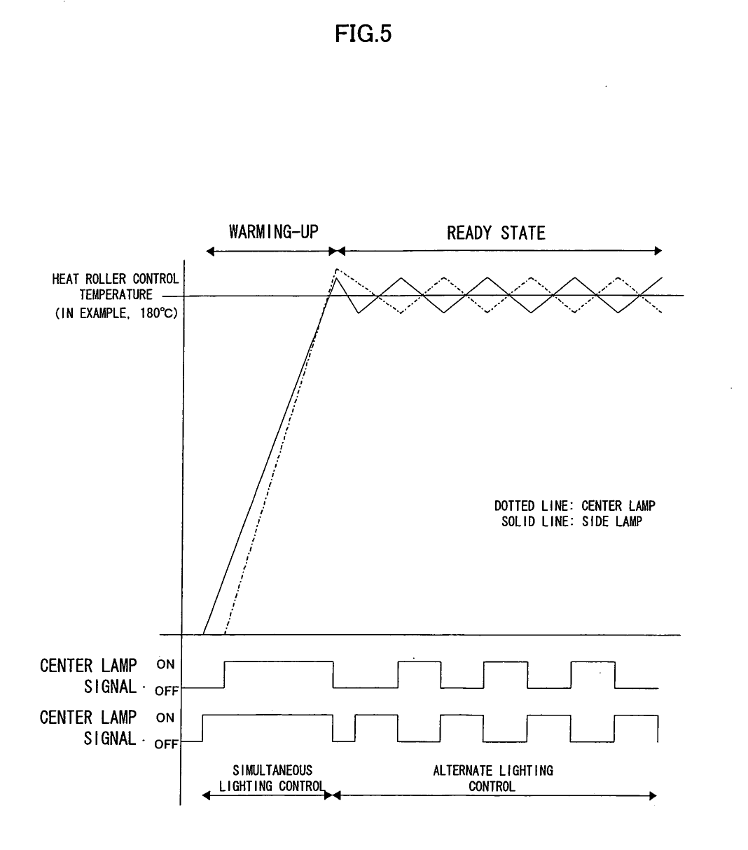

FIG. 5 is a diagram for explaining lighting control for the heater lamp 109A and the heater lamp 109B. As shown in the figure, the heater lamp 109A and the heater lamp 109B in this embodiment perform alternate lighting control except “warm-up time” when an original reading (scan) operation, an operation by a main motor (copy operation), and the like are not performed. In performing this alternate lighting control, the fixing device according to this embodiment subjects the heater lamp 109A to heating control such that a surface temperature of the heating roller 102 rises to 180° C. using the thermistor 106 (a temperature detecting unit) and subjects the heater lamp 109B to heating control such that a surface temperature of the heating roller 102 rises to 180° C. using the thermistor 107 (a temperature detecting unit). In the alternate lighting control, in order to prevent occurrence of flicker, it is preferable to set a maximum lighting time for lighting each of the heater lamp 109A and the heater lamp 109B as long as possible. In this embodiment, the maximum lighting time for each of the heater lamp 109A and the heater lamp 109B is set to 2.5 seconds.

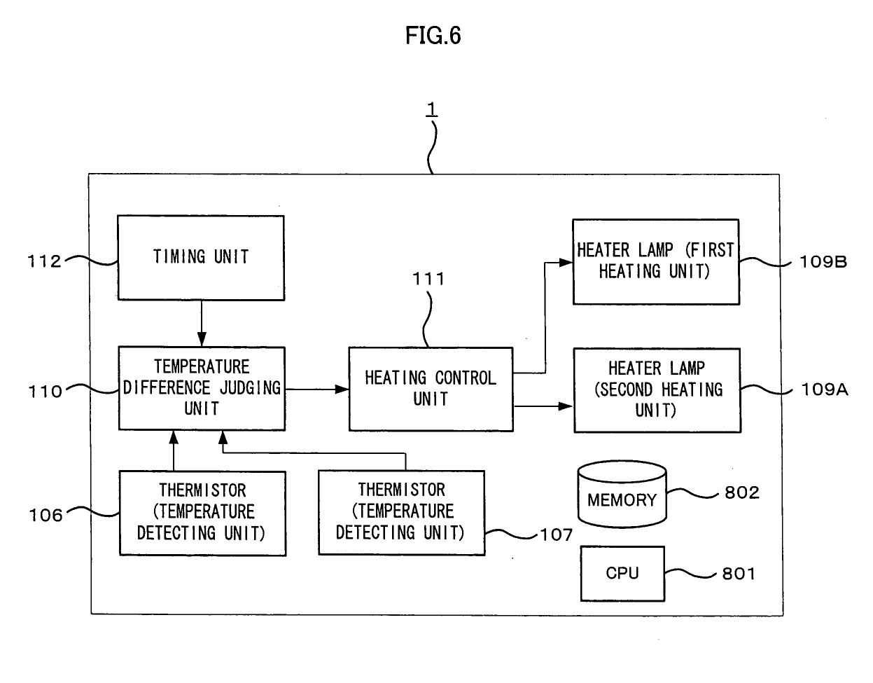

FIG. 6 is a functional block diagram for explaining the fixing device 1 and the image forming apparatus M including the same according to this embodiment. The fixing device 1 according to this embodiment includes the heater lamp 109A (second heating means), the heater lamp 109B (first heating means), a temperature difference judging unit (temperature difference judging means) 110, a heating control unit (heating control means) 111, a timing unit (timing means) 112, the thermistor (temperature detecting means) 106, the thermistor (temperature detecting means) 107, a CPU 801, and a MEMORY 802.

The heater lamp 109B heats portions near ends in the rotation axis direction of the heating roller 102. In an example described in this embodiment, the heater lamp 109B includes one heater that has a luminous intensity distribution for mainly heating portions near both the ends in the rotation axis direction of the heating roller 102. However, the heater lamp 109B is not limited to this example. For example, heaters dependent from each other may be provided in the portions at both the ends in the rotation axis direction of the heating roller 102.

The heater lamp 109A heats the center in the rotation axis direction of the heating roller 102.

The timing unit 112 measures an elapsed time from time of power-on or time of reset processing from a power saving mode (warming-up processing, etc.).

The temperature difference judging unit 110 judges whether a temperature difference between the heating roller 102 and the pressure roller 103 is equal to or more than a predetermined value. The predetermined value is a value set depending on an apparatus structure or the like of the image forming apparatus M including the fixing device 1. In this embodiment, the predetermined value is set to, for example, about 22° C.

Specifically, when the elapsed time measured by the timing unit 112 is equal to or shorter than a predetermined time, the temperature difference judging unit 110 can judge that there is a temperature difference equal to or larger than the predetermined value. The “predetermined time” in this case depends on the apparatus structure and is set to about one minute.

The temperature difference judging unit 110 can judge a temperature difference between the heating roller 102 and the pressure roller 103 on the basis of temperature detected by the temperature detecting unit 113.

In the case in which the temperature difference judging unit 110 judges that there is a temperature difference equal to or larger than the predetermined value when predetermined heat processing (e.g., warming-up processing) for making it possible to perform fixing processing in the fixing device is started by the heater lamp 109B, the heating control unit 111 controls a supplied heat quantity per a unit time (a total heat quantity supplied in a unit time) by the heater lamp 109B in a period from a start time of the predetermined heat processing by the heater lamp 109B until a start time of fixing processing to be larger than a supplied heat quantity per a unit time (a total heat quantity supplied in a unit time) by the heater lamp 109B at the time of the fixing processing (a state in which the heat processing is stably applied to the heating roller 102 by the heater lamps at the time of fixing processing).

Specifically, in the case in which the temperature difference judging unit 110 judges that there is a temperature difference equal to or larger than the predetermined value when predetermined heat processing for making it possible to perform fixing processing in the fixing device is started by the heater lamp 109B, the heating control unit 111 controls a target temperature of heat processing by the heater lamp 109B in a period from a start time of predetermined heat processing by the heater lamp 109B until a start time of fixing processing to temperature (e.g., 190° C.) to be higher than a target temperature (e.g., 180° C.) of heat processing by the heater lamp 109B at the time of the fixing processing.

Besides, in the case in which the temperature difference judging unit 110 judges that there is a temperature difference equal to or larger than the predetermined value when predetermined heat processing for making it possible to perform fixing processing in the fixing device is started by the heater lamp 109B, the heating control unit 111 can also control a heating time by the heater lamp 109B in a period from a start time of predetermined heat processing by the heater lamp 109B until a start time of fixing processing to be longer than a heating time by the heater lamp 109B at the time of the fixing processing.

The CPU 801 has a role of performing the respective kinds of processing in the fixing device. The CPU 801 also has a role of realizing various functions by executing programs stored in the MEMORY 802. The MEMORY 802 is constituted by, for example, a ROM or a RAM and has a role of storing various kinds of information and programs used in the fixing device.

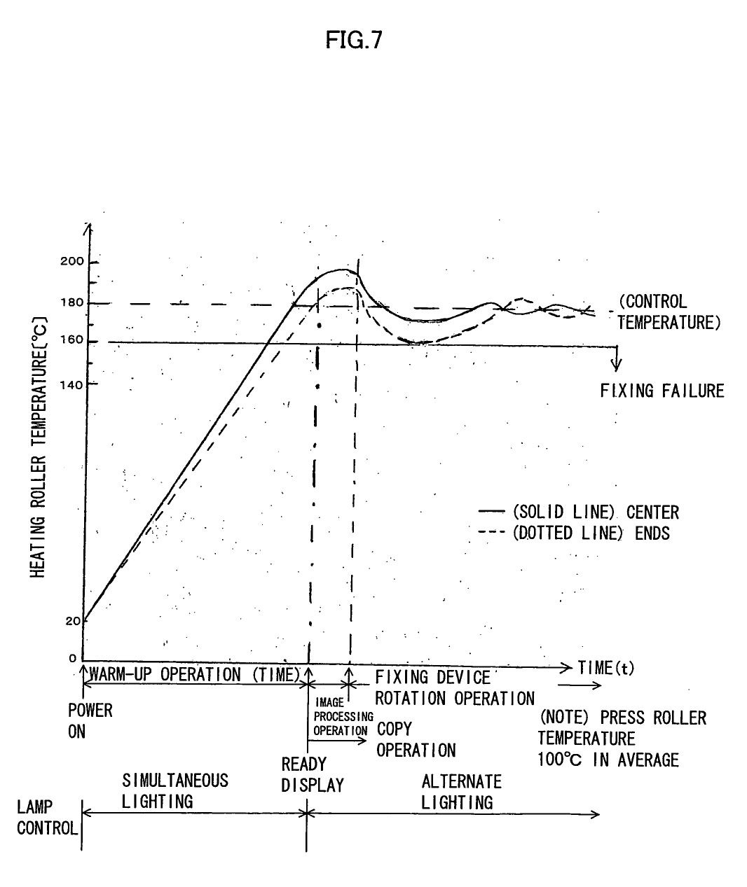

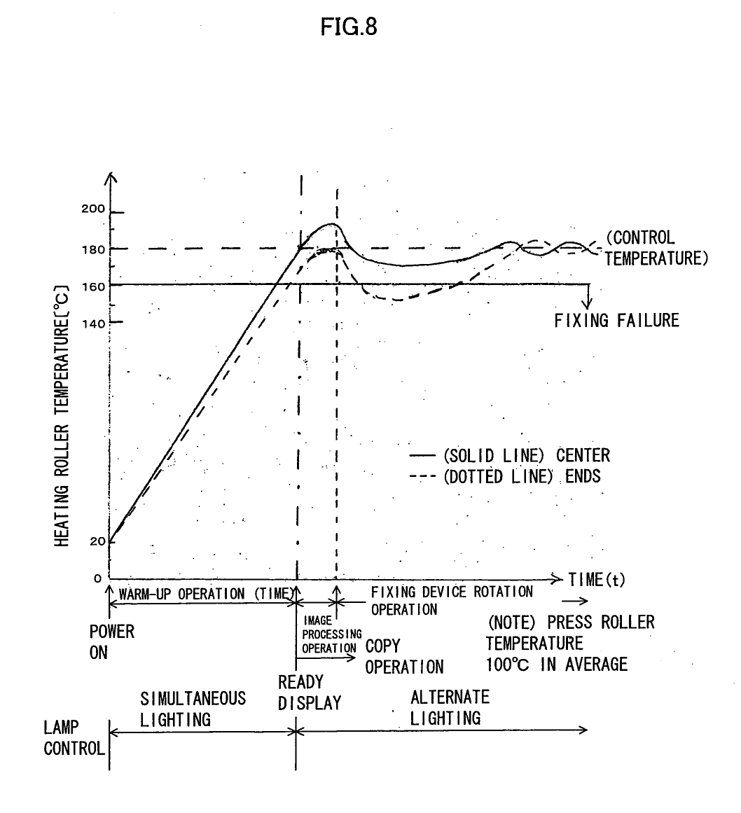

FIGS. 7 and 8 are graphs for explaining a temperature change in the heating roller 102 at the time when a copy operation is performed immediately after warm-up from a state in which the heating roller 102 and the pressure roller 103 in the fixing device are cold in control for alternately lighting the heater lamp 109A and the heater lamp 109B in the conventional fixing device that performs temperature control. FIG. 7 shows a temperature change in the heating roller 102 in the case in which warm-up is completed when temperatures of both the center and the ends in the rotation axis direction of the heating roller 102 reach a fixable temperature (in an example, 180° C.). FIG. 8 shows a temperature change in the heating roller 102 in the case in which warm-up is completed when temperature of at least any one of the center and the ends in the rotation axis direction of the heating roller 102 reaches the fixable temperature (in the example, 180° C.).

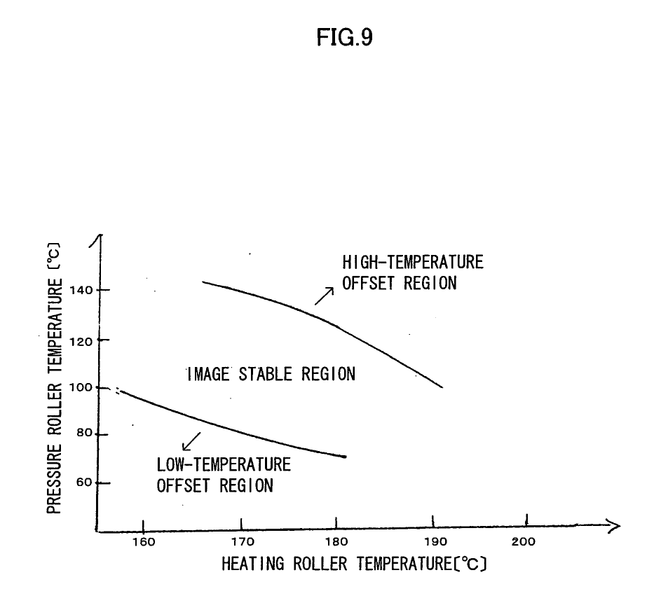

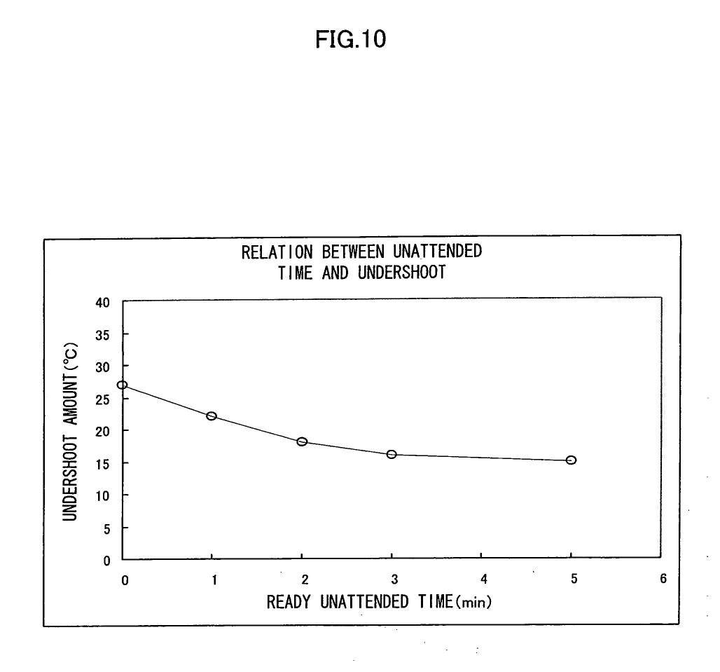

FIG. 9 is a graph showing a relation between the temperature of the heating roller 102 and an area of occurrence of image stain (surface stain). FIG. 10 is a graph showing a relation between an unattended time (a ready unattended time) of the image forming apparatus M in a standby state and a temperature change amount (an undershoot amount with respect to a target temperature (180° C.)) of the heating roller 102 at a start time of copy.

As it is seen from FIGS. 7 to 10, the heating roller 102 in the fixing device is deprived of a large amount of heat by a cold pressure roller and a cold transfer sheet at the time of a copy operation immediately after warm-up processing from a state in which the heating roller 102 is cold. An undershoot phenomenon with respect to the fixable temperature often increases. Such an undershoot phenomenon of a heating roller temperature with respect to the fixable temperature causes an image failure such as a fixing failure.

As shown in FIG. 7, when heating control for sufficiently satisfying a fixing property is performed, a longer warm-up time is required. On the other hand, as shown in FIG. 8, when heating control for making it possible to perform fixing when temperature of a part of the heating roller reaches the fixable temperature is performed, there is a problem in that, although the warm-up time is reduced, the fixing property cannot be satisfied.

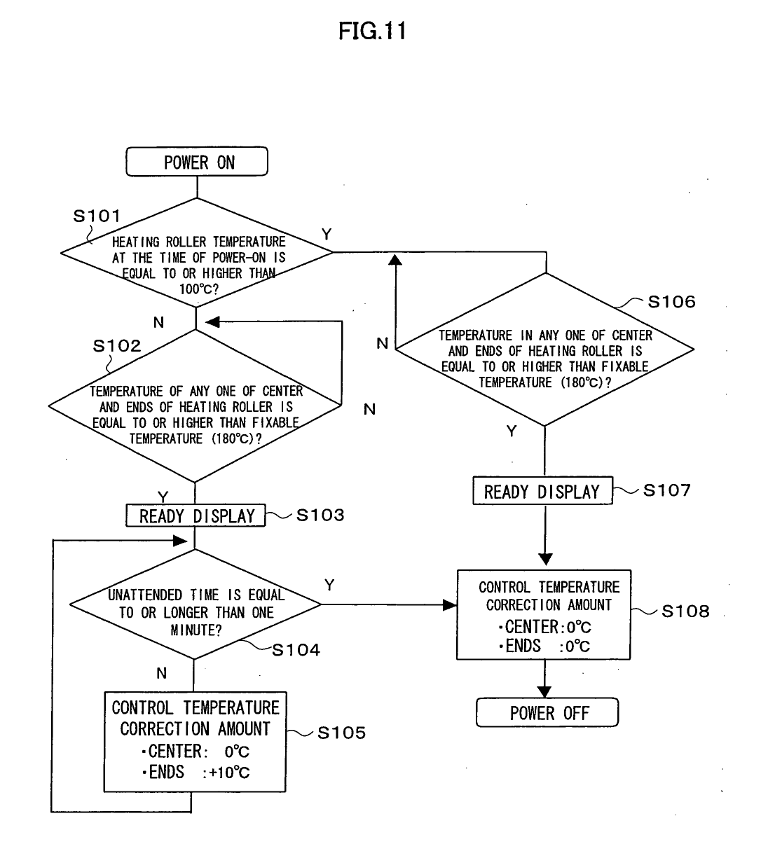

FIG. 11 is a flowchart for explaining a flow of processing in the fixing device according to this embodiment.

The temperature difference judging unit 110 detects, using the thermistor 106 and the thermistor 107, the temperature of the heating roller 102 at time of power-on of the image forming apparatus M and judges whether the temperature of the heating roller 102 is equal to or higher than 100° C. (S101).

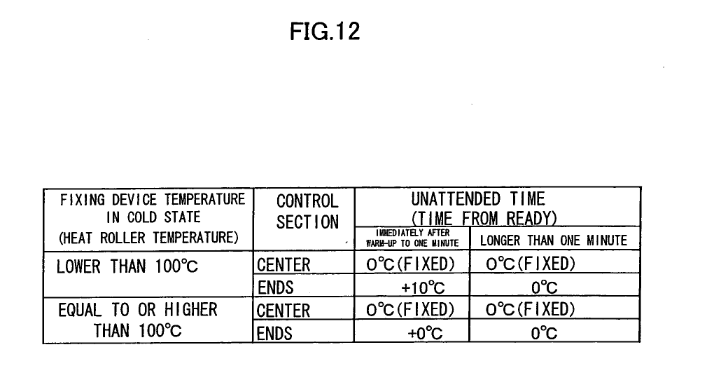

When the temperature of the heating roller 102 is lower than 100° C. (S101, N) and temperature of at least any one of the center and the ends in the rotation axis direction of the heating roller 102 reaches the fixable temperature (S102, Y), the temperature difference judging unit 110 performs ready display on a not-shown display in the image forming apparatus M (S103). Until an unattended time (a warming-up time) of the image forming apparatus M becomes equal to or longer than one minute (S104), the temperature difference judging unit 110 sets a control temperature of the heater lamp 109B, which heats portions near ends in the rotation axis direction of the heating roller 102, to temperature about 10° C. higher than the fixable temperature (S105). FIG. 12 is a table showing control conditions in heating control for the heating roller 102. The heating control for the heating roller 102 by the heating control unit 111 is performed on the basis of the table shown in the figure.

When the temperature of the heating roller 102 is equal to or higher than 100° C. (S101, Y) and temperature of any one of the center and the ends in the rotation axis direction of the heating roller 102 reaches the fixable temperature (S106, Y), the heating control unit 111 performs ready display on the not-shown display in the image forming apparatus M (S107).

After the ready display is performed as described above (S107) or when the unattended time (the warming-up time) of the image forming apparatus M becomes equal to or longer than one minute (S104, Y), the heating control unit 111 sets a control temperature for the heater lamp 109B, which heats portions near ends in the rotation axis direction of the heating roller 102, to the same temperature as the fixable temperature (S108).

In this embodiment, when it is judged that the heating roller 102 and the like of the fixing device 1 is in a cold state (when a heating roller temperature is lower than 100° C.) according to the control conditions shown in FIG. 12 and the processing of the flowchart shown in FIG. 11, a control temperature for the center is maintained and a control temperature for only the ends is raised for a fixed time after turning on the power supply regardless of whether the image forming apparatus M is in the standby state or the copy state. This makes it possible to eliminate an image failure such as a fixing failure due to the undershoot phenomenon at the time of a copy operation immediately after warm-up, perform stable image supply, and reduce a warm-up time.

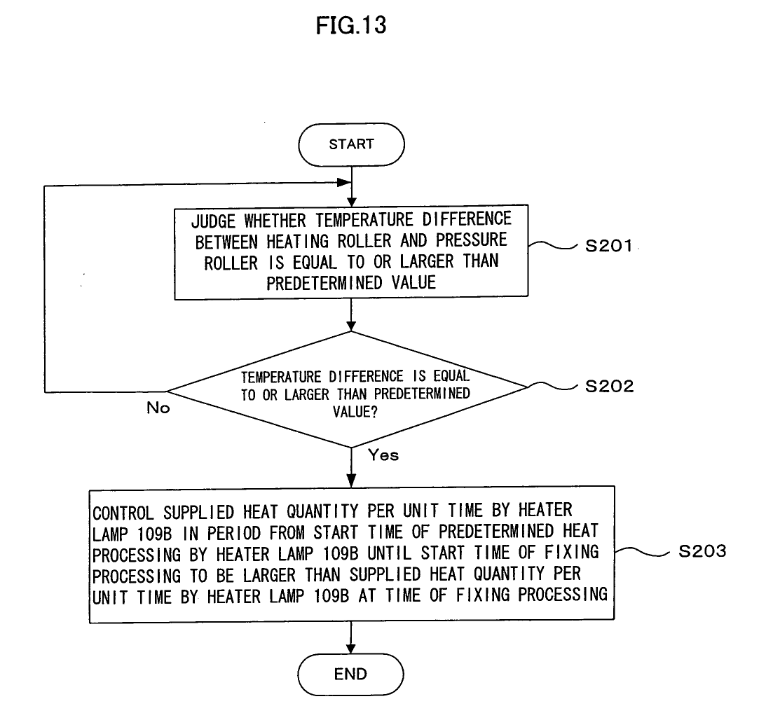

FIG. 13 is a flowchart for explaining a schematic flow of processing (a temperature control method) in the fixing device according to this embodiment.

First, the temperature difference judging unit 110 judges whether a temperature difference between the heating roller and the pressure roller is equal to or larger than a predetermined value (S201). As the judgment of a temperature difference, for example, an elapsed time from time of power-on or time of reset from the power saving mode is measured and, when the elapsed time measured is equal to or shorter than a predetermined time, it is judged there is a temperature difference equal to or larger than the predetermined value. It is also possible to detect the temperature of the heating roller and judge a temperature difference between the heating roller and the pressure roller on the basis of the temperature detected.

Subsequently, in the case in which it is judged that there is a temperature difference equal to or larger than the predetermined value when predetermined heat processing for making it possible to perform fixing processing in the fixing device is started by the heater lamp 109B (S202, Yes), the heating control unit 111 controls a supplied heat quantity per a unit time by the heater lamp 109B in a period from a start time of the predetermined heat processing to a start time of the fixing processing to be larger than a supplied heat quantity per a unit time by the heater lamp 109B at the time of the fixing processing (S203).

Specifically, it is desirable that, in the case in which there is a temperature difference equal to or larger than the predetermined value when the predetermined heat processing for making it possible to perform the fixing processing in the fixing device is started by the first heating unit, the heating control unit 111 controls a target temperature of heat processing by the first heating unit in a period from a start time of the predetermined heat processing by the first heating unit until a start time of the fixing processing to be higher than a target temperature of the heat processing by the first heating unit at the time of the fixing processing.

Besides, in the case in which it is judged that there is a temperature difference equal to or larger than the predetermined value when the predetermined heat processing for making it possible to perform fixing processing in the fixing device is started by the first heating unit, the heating control unit 111 can also control a heating time by the first heating unit in a period from a start time of the predetermined heat processing by the first heating unit until a start time of the fixing processing to be longer than a heating time by the first heating unit at the time of the fixing processing.

The respective steps in the processing in the fixing device are realized by causing the CPU 801 to execute a temperature control program stored in the MEMORY 802.

In the explanation of this embodiment, a function for carrying out the invention is recorded in the apparatus in advance. However, the invention is not limited to this. The same function may be downloaded from a network to the apparatus or the same function recorded in a recording medium may be installed in the apparatus. The recording medium may be a recording medium of any form such as a CD-ROM as long as the recording medium can store a program and is readable by the apparatus. The function obtained by installation or download in advance in this way may be a function realized in cooperation with an OS (Operating System) or the like in the apparatus.

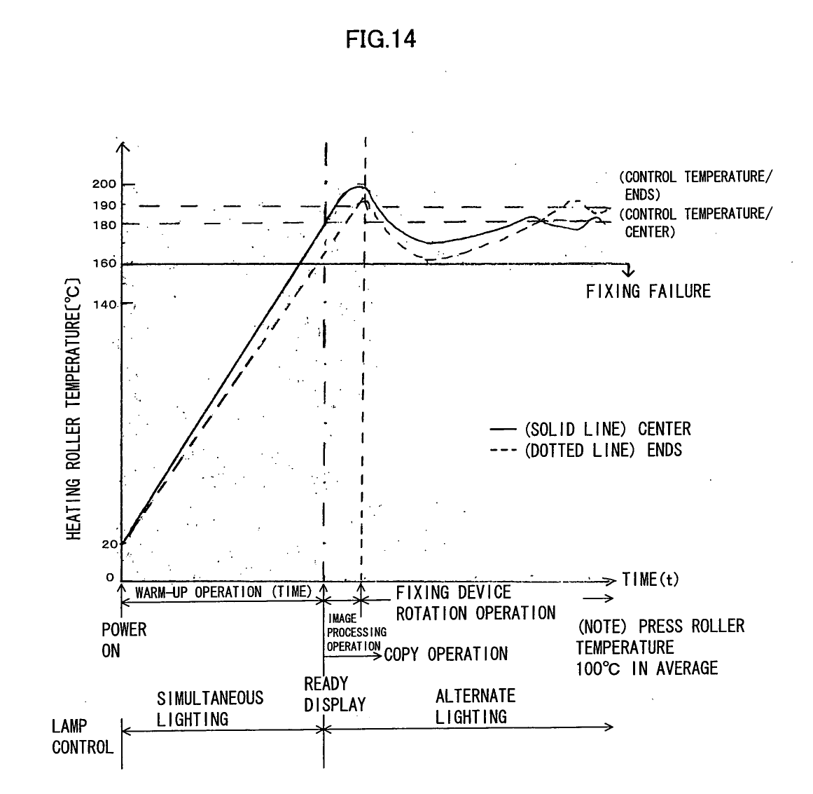

FIG. 14 is a graph showing a temperature change in the heating roller 102 at the time when a copy operation is performed immediately after warm-up from a state in which the fixing device is cold in the case in which the heater lamp 109A and the heater lamp 109B are alternately lighted in the fixing device 1 according to the embodiment.

As described above, in this embodiment, when it is judged that the fixing device is in a cold state (a state in which there is such a temperature difference as to cause a fixing failure between the heating roller and the pressure roller), temperature control for the center of the heating roller is maintained and temperature of only the ends of the heating roller is raised within a predetermined time in which warming-up after turning on the power supply is performed (a range in which the undershoot phenomenon is large) regardless of, for example, whether the image forming apparatus including the fixing device is in the standby state or the copy state. This makes it possible to provide an image forming apparatus that controls occurrence of an image failure such as a fixing failure due to the undershoot phenomenon at the time of a copy operation immediately after warm-up, performs image formation processing with a stable image quality, and has a short warm-up time.

The invention has been explained in detail with reference to the specific forms. However, it would be apparent for those skilled in the art that various alterations and modification can be made without departing from the spirit and the scope of the invention.

As described above in detail, according to the invention, it is possible to provide a fixing technique that can control occurrence of a fixing failure in image formation processing immediately after warm-up from a state in which a heating roller is cold.

What is claimed is:

1. A fixing device that brings a sheet having a toner image transferred thereon into press-contact with a heating roller using a pressure roller to heat-fix the toner image on the sheet and causes the sheet to pass in a center position in a rotation axis direction of the heating roller, comprising:
at least one first heating unit configured to heat portions near ends in a rotation axis direction of the heating roller;
a second heating unit configured to heat a center in the rotation axis direction of the heating roller;
a temperature difference judging unit configured to judge whether a temperature difference between the heating roller and the pressure roller is equal to or larger than a predetermined value; and
a heating control unit configured to control, in the case in which the temperature difference judging unit judges that a temperature difference is equal to or larger than the predetermined value when predetermined heat processing for making it possible to perform fixing processing in the fixing device is started by the first heating unit, a supplied heat quantity per a unit time by the first heating unit in a period from a start time of the predetermined heat processing by the first heating unit until a start time of the fixing processing to be larger than a supplied heat quantity per a unit time by the first heating unit at the time of fixing processing.

2. A fixing device according to claim 1, further comprising a timing unit configured to measure an elapsed time from time of power-on or time of reset from a power saving mode, wherein
the temperature difference judging unit judges, when the elapsed time measured by the timing unit is equal to or shorter than a predetermined time, that there is a temperature difference equal to or larger than the predetermined value.

3. A fixing device according to claim 1, further comprising a temperature detecting unit configured to detect temperature of the heating roller, wherein
the temperature difference judging unit judges a temperature difference between the heating roller and the pressure roller on the basis of the temperature detected by the temperature detecting unit.

4. A fixing device according to claim 1, wherein the heating control unit controls, in the case in which the temperature difference judging unit judges that there is a temperature difference equal to or larger than the predetermined value when predetermined heat processing for making it possible to perform fixing processing in the fixing device is started by the first heating unit, a target temperature of heat processing by the first heating unit in a period from a start time of the predetermined heat processing by the first heating unit until a start time of the fixing processing to be higher than a target temperature of heat processing by the first heating unit at the time of fixing processing.

5. A fixing device according to claim 1, wherein the heating control unit controls, in the case in which the temperature difference judging unit judges that there is a temperature difference equal to or larger than the predetermined value when the predetermined heat processing for making it possible to perform fixing processing in the fixing device is started by the first heating unit, a heating time by the first heating unit in a period from a start time of the predetermined heat processing by the first heating unit until a start time of the fixing processing to be longer than a heating time by the first heating unit at the time of the fixing processing.

6. A fixing device that brings a sheet having a toner image transferred thereon into press-contact with a heating roller using a pressure roller to heat-fix the toner image on the sheet and causes the sheet to pass in a center position in a rotation axis direction of the heating roller, comprising:
at least one first heating means for heating portions near ends in a rotation axis direction of the heating roller;
second heating means for heating a center in the rotation axis direction of the heating roller;
temperature difference judging means for judging whether a temperature difference between the heating roller and the pressure roller is equal to or larger than a predetermined value; and
heating control means for controlling, in the case in which the temperature difference judging means judges that a temperature difference is equal to or larger than the predetermined value when predetermined heat processing for making it possible to perform fixing processing in the fixing device is started by the first heating means, a supplied heat quantity per a unit time by the first heating means in a period from a start time of the predetermined heat processing by the first heating means until a start time of the fixing processing to be larger than a supplied heat quantity per a unit time by the first heating means at the time of fixing processing.

7. A fixing device according to claim 6, further comprising timing means for measuring an elapsed time from time of power-on or time of reset from a power saving mode, wherein
the temperature difference judging means judges, when the elapsed time measured by the timing means is equal to or shorter than a predetermined time, that there is a temperature difference equal to or larger than the predetermined value.

8. A fixing device according to claim 6, further comprising temperature detecting means for detecting temperature of the heating roller, wherein
the temperature difference judging means judges a temperature difference between the heating roller and the pressure roller on the basis of the temperature detected by the temperature detecting means.

9. A fixing device according to claim 6, wherein the heating control means controls, in the case in which the temperature difference judging means judges that there is a temperature difference equal to or larger than the predetermined value when predetermined heat processing for making it possible to perform fixing processing in the fixing device is started by the first heating means, a target temperature of heat processing by the first heating means in a period from a start time of the predetermined heat processing by the first heating means until a start time of the fixing processing to be higher than a target temperature of heat processing by the first heating means at the time of fixing processing.

10. A fixing device according to claim 6, wherein the heating control means controls, in the case in which the temperature difference judging means judges that there is a temperature difference equal to or larger than the predetermined value when the predetermined heat processing for making it possible to perform fixing processing in the fixing device is started by the first heating means, a heating time by the first heating means in a period from a start time of the predetermined heat processing by the first heating means until a start time of the fixing processing to be longer than a heating time by the first heating means at the time of the fixing processing.

11. A temperature control method in a fixing device that brings a sheet having a toner image transferred thereon into press-contact with a heating roller using a pressure roller to heat-fix the toner image on the sheet and causes the sheet to pass in a center position in a rotation axis direction of the heating roller, the fixing device including at least one first heating unit that heats portions near ends in a rotation axis direction of the heating roller and a second heating unit that heats a center in the rotation axis direction of the heating roller, the temperature control method comprising:
judging whether a temperature difference between the heating roller and the pressure roller is equal to or larger than a predetermined value; and
setting, in the case in which it is judged that a temperature difference is equal to or larger than the predetermined value when predetermined heat processing for making it possible to perform fixing processing in the fixing device is started by the first heating unit, a supplied heat quantity per a unit time by the first heating unit in a period from a start time of the predetermined heat processing by the first heating unit until a start time of the fixing processing larger than a supplied heat quantity per a unit time by the first heating unit at the time of fixing processing.

12. A temperature control method according to claim 11, further comprising, measuring an elapsed time from time of power-on or time of reset from a power saving mode, wherein
it is judged, when the elapsed time measured is equal to or shorter than a predetermined time, that there is a temperature difference equal to or larger than the predetermined value.

13. A temperature control method according to claim 11, further comprising, detecting temperature of the heating roller, wherein
a temperature difference between the heating roller and the pressure roller is judged on the basis of the temperature detected.

14. A temperature control method according to claim 11, wherein, in the case in which it is judged that there is a temperature difference equal to or larger than the predetermined value when predetermined heat processing for making it possible to perform fixing processing in the fixing device is started by the first heating unit, a target temperature of heat processing by the first heating unit in a period from a start time of heat processing by the first heating unit until a start time of the fixing processing is controlled to be higher than a target temperature of heat processing by the first heating unit at the time of fixing processing.

15. A temperature control method according to claim 11, wherein, in the case in which it is judged that there is a temperature difference equal to or larger than the predetermined value when the predetermined heat processing for making it possible to perform fixing processing in the fixing device is started by the first heating unit, a heating time by the first heating unit in a period from a start time of the predetermined heat processing by the first heating unit until a start time of the fixing processing is controlled to be longer than a heating time by the first heating unit at the time of the fixing processing.
